(19) United States
(12) Patent Application Publication
(10) Pub. No.: US 2025/0241345 A1
(43) Pub. Date: Jul. 31, 2025

(54) METHOD OF MAKING FROZEN SWEET POTATO HASH BROWN PATTIES AND THE PRODUCTS FORMED THEREBY.

(71) Applicant: Kendall Brooks, Richton Park, IL (US)

(72) Inventor: Kendall Brooks, Richton Park, IL (US)

(21) Appl. No.: 19/032,447

(22) Filed: Jan. 21, 2025

(51) Int. Cl. A23L 19/18; A23L 19/10; A23L 29/212

(52) U.S. Cl. CPC A23L 19/18; A23L 19/105; A23L 29/212

(57) ABSTRACT

This invention covers the method of making frozen sweet potato hash brown patties (Convolvulaceae, Morning glory family potatoes), which can be final cooked in a variety of ways to provide an additional healthier option of sweet potato hash brown patties to consumers on a commercial level, having excellent taste, texture, and handling characteristics.

### BACKGROUND OF INVENTION

This invention process objective is the preparation process of making sweet (yam variety) potato hash brown patties, processed to be cryogenically frozen by means of liquid oxygen, at approximately −320° F., minimizing ice crystal formation, preserving texture and taste while working well with packaging, which makes the product adaptable to be cooked in oil, microwave, toaster, and other reheating means.

Currently commercially available what is mostly used for frozen potato hash brown patties are either russet or idaho potatoes, and while the current frozen potato hash brown patties are satisfactory in many respects, sweet potato hash brown patties are a healthier option, sweet flavorful than that of the latter mentioned.

Notwithstanding the success of the frozen potato hash brown patties now in commercial use, there has been a long term need to provide a more healthy option for frozen sweet (yam) potato hash brown patties. Through processing, the cryogenic freezing process retains a considerable amount of the frozen sweet potato hash brown patties flavor, more vitamin A, antioxidants, lower glycemic levels, higher fiber and more protein than frozen potato hash brown patties. After freezing, the sweet potato hash brown patties can be final cooked by baking, pan-frying, deep frying, grilling, also by means of a toaster, air fryer and microwave oven, to include all but not only limited to these re-heating types.

### SUMMARY OF INVENTION

This invention includes the means of formulating a product of frozen sweet (yams) potato hash brown patties which can be final cooked in a wide variety of ways that maintains a substantial amount of the frozen sweet potato hash brown patties flavor. In the latter two instances, it is preferred to cook the patties in oil before final freezing. When final cooked, the frozen sweet potato hash brown patties of the invention retains considerably more of the natural potato taste and texture than the prior frozen potato hash brown patties notwithstanding how they are final cooked. These and other features and advantages of the present invention will become more apparent from the following detailed discussion. When final cooked, the sweet potato hash brown patties of this invention preserves the natural sweet potato taste and retains more nutrients found in those of russet potato hash browns.

### BRIEF DESCRIPTION OF DRAWINGS

FIG. 1. Flow chart (sketched) diagram illustrating the processing steps which embodies the features of this invention; and

FIG. 2. Sketch view of frozen sweet potato hash brown patty formed in accordance with the embodiment of the invention; and

FIG. 3. Sketch view of packaging for storage of frozen sweet potato hash browns (post-freeze and storage)

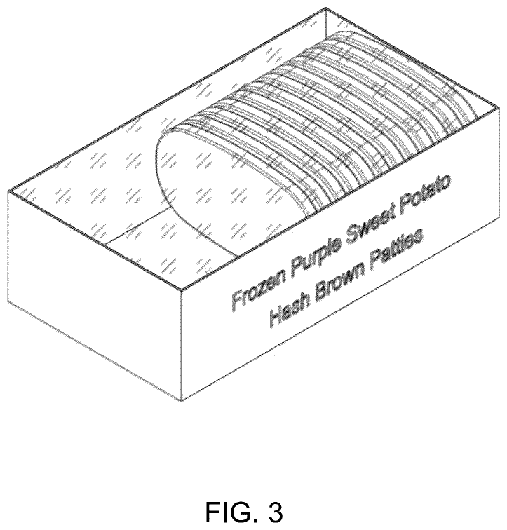

### DESCRIPTION OF A PREFERRED EMBODIMENT

The process of forming frozen sweet potato hash brown patties in accordance with the invention comprises cutting up peeled or unpeeled sweet potatoes into relatively large sized chunks which predominantly have a minimum dimension of not less than inch. Maximum dimensions of the chunks are much less important than the minimum dimension but the maximum should not be more than the thickness of the patty.

The sweet potato chunks are steamed or water blanched at a temperature typically of about 170 to 220° F. for about 2 to 20 minutes. To prevent discoloration of the 30 potatoes, sodium acid pyrophosphate may be added to the aqueous medium in amounts of about 0.05 to 0.25% (by weight). To the final cooked product dextrose may be also normally added to the aqueous media in amounts of up to about 35 2%.

The water or steam cooked frozen sweet potato hash brown patties chunks are usually surface dried at a temperature of about 120° to 180° F. to prevent excessive amounts of water from entering the hot oil bath subsequently used to oil blanch or pan 40 fry frozen sweet potato hash brown chunks. The time for drying varies depending upon the size of the chunk but usually is less than two minutes.

The water or steam blanched sweet potato chunks are oil blanched by submerging the sweet potato chunks into an oil 45 bath at a temperature of about 300° to 375° F. preferably about 320° F. to 370° F., for about 0.25 to 2 minutes, preferably about 0.5 to 1.5 minutes depending upon the size of the sweet potato chunks.

The oil blanched sweet potato chunks are drained to remove excessive oil on the surface thereof and then mixed with an aqueous solution of starch or gum or mixture thereof and formed into a frozen sweet potato hash brown patties. The aqueous starch or gum solution contains about 3 to 25% (by weight), preferably about 5 to 12% (by weight), of 55 starch or gum and is added to the oil blanched sweet potato chunks at a rate of about 5 to 20 grams of starch or gum solution per 100 grams of sweet potatoes. A wide variety of starches and gums may be used as binders.

After forming the sweet potato chunks into patties, they are cryogenically frozen by means of liquid oxygen, at approximately −320° F.

4.60 of about 30 to 60° F. The frozen patties can then be stored indefinitely.

For frozen sweet potato hash brown patties which are to be final cooked by microwave radiation or toasting, it is preferred to oil blanch the frozen sweet potato hash brown patties after forming into a patty but before the final freezing with the oil blanch temperature ranging from about 325° to 380° F., preferably about 350 to 370° F. for about one to four minutes, preferably about 1.5 to 3 minutes. If the processing line has only one oil blanching station, it may be desirable to freeze the patty after forming, subsequently oil blanching the patty at the above times and temperatures and then refreezing the patty for subsequent storage.

The conditions for final cooking of the frozen sweet potato hash brown patties vary considerably depending upon the size of the patty, but in general for patties approximately inch thick the following conditions have been found to provide excellent results both as to taste and texture integrity of the patty.

### Final Cooking Conditions

### Method of Heating

| Minutes | Temperature(F.) | Time |
|---|---|---|
| Deep Fry | 340-375 | 2-3 |
| Oven Bake | 375-425 | 10-25 |
| Grill | 350-375 | 5-8(per |
| | | side toast) |
| Microwave | 650 watt | 1-2 |

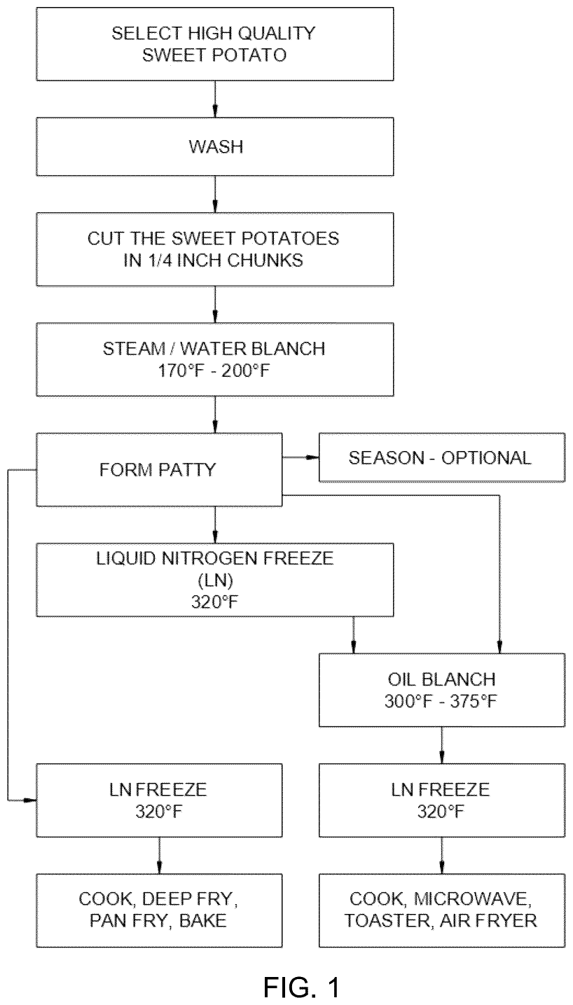

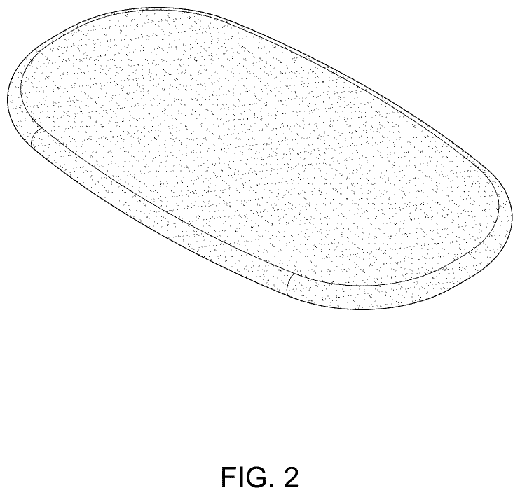

FIG. 1 illustrates flow diagrams of various processing steps which are suitable for use in the process of the invention. FIG. 2 is a perspective view of a frozen sweet potato hash brown patties formed in accordance with the invention.

The following examples are provided to further describe the processes and products which embody features of the present invention.

### EXAMPLE 1

Sweet potato chunks inch by inch were blanched in water at a temperature of about 180° for about five minutes, surface dried by heating at about 150° F. for about 40 seconds, then oil blanched at a temperature of about 350 for about 45 seconds. The oil blanched chunks were mixed with an aqueous solution of Instant Pure-Flo starch at a concentration of about 8% (by weight) and mixed with the oil blanched sweet potato chunks at a rate of about 10 grams of solution per 100 grams of sweet potatoes. The sweet potato starch mixture was formed into patties and then frozen at a temperature of −40° F. The frozen patties were subsequently final cooked by heat-ing in an oven at 400° F. for 18 minutes, by grilling at 375° F. on each side for six minutes or by deep frying at 350° F. for 2.25 minutes. In each case, the frozen sweet potato hash brown patties remained intact throughout the final cooking and exhibited excellent taste and texture.

### EXAMPLE 2

Sweet potato chunks inch by inch by inch were prepared in the manner set forth in Example 1 except that, after freezing, the patties were oil blanched for about 2.25 minutes at 360° F. and then refrozen at −40° F. The patties were finally cooked by deep frying at 350″ F. for 2.25 minutes, by oven baking at 400° F. for 14 minutes, by grilling at 365° F. for five minutes on each side, by toasting for 4.25 minutes or by microwave radiation heating (650 watts) for about 1.5 minutes. All the patties remained intact during the final cooking process and exhibited excellent taste and texture. After microwave radiation treatment, the patties were not the least bit rubbery and essentially no oil dripped from the patties while they were being toasted.

### EXAMPLE 3

Sweet potato chunks ¼ inch by ½ inch by ½ inch were prepared in the manner set forth in Example 1 except that after the patties were formed, they were oil blanched at 360° F. for 2.25 minutes then frozen in −40° F. The frozen patties were then final cooked in a manner described in example 2. All of the patties remained intact during the final cooking process and exhibited excellent taste and texture. The patties that were final cooked by microwave radiation were not the least bit rubber and the patties which were toasted showed little or no oil dripping during toasting.

As is evident from the above, the process of the present invention provides a relatively straight-forward process which provides a high quality frozen sweet potato hash brown patties that has excellent taste and texture, a low oil content and excellent handling characteristics throughout processing and final cooking. Other advantages have also been found. For example, the frozen patties can be broken up while being grilled to form excellent tasting frozen sweet potato hash brown patties. Moreover, other modifications and improvements can be made to the invention without departing from the scope thereof.

1. A method of preparing frozen sweet potato hash brown patties for freezing and storage comprising:
a. cutting up sweet potatoes into relatively large chunks having a predominant minimum dimension of not less than about ¼ inch;
b. cooking the sweet potato chunks in an aqueous media selected from the group consisting of steam and water;
c. further cooking the sweet potato chunks in oil;
d. mixing the sweet potato chunks cooked in oil with an aqueous solution of starch, gum or mixtures thereof; and
e. then forming the mixture into frozen sweet potato hash brown patties.

2. The method of claim 1 includes the step of freezing the formed patty.

3. The method of claim 2 includes the steps of cooking the frozen sweet patty in oil and then freezing the patty.

4. The frozen sweet potato hash brown patties prepared by the method of claim 3.

5. The method of claim 3 includes the step of final cooking the frozen sweet potato hash brown patties by a method selected from the group consisting of microwave heating or toasting.

6. The frozen potato hash brown patties prepared by the method of claim 5.

7. The method of claim 2, wherein the formed patty is cryogenically frozen by means of liquid nitrogen, at approximately −320° F.

8. The frozen sweet potato hash brown patties prepared by the method of claim 7.

9. The frozen sweet potato hash brown patties prepared by the method of claim 2.

10. The method of claim 2 including the step of final cooking the frozen sweet potato hash brown patties by a method selected from the group consisting of:
a. baking at a temperature from about 375° to 425° F.;
b. grilling at a temperature from about 350° to 375° F.;
c. deep frying at a temperature from about 340° to 375° F.;
d. microwave heating; and
e. toasting.

11. The frozen sweet potato hash brown patties prepared by the method of claim 10.

12. The method of claim 1 includes the steps of cooking the formed patty in oil and then freezing the patty.

13. The frozen sweet potato hash brown patties prepared by the method of claim 12.

14. The method of claim 12 includes the step of final cooking the frozen sweet potato hash brown patties by a method selected from the group consisting of microwave heating or toasting.

15. The frozen sweet potato hash brown patties prepared by the method of claim 14.

16. The method of claim 1 wherein the frozen sweet potato hash brown patties chunks are cooked in an aqueous medium at a temperature from about 170° to 220° F.

17. The method of claim 1 wherein the frozen sweet potato hash brown patties chunks are cooked in oil at a temperature from about 300° to 375° F.

18. The method of claim 1 wherein the frozen sweet potato hash brown patties chunks are cooked in oil at a temperature from about 320° to 370° F.

19. A method of preparing frozen sweet potato hash brown patties comprising:
a. cutting up frozen sweet potato hash brown patties into relatively large chunks with the minimum dimensions of such chunks being predominantly at least ¼ inch;
b. cooking the frozen sweet potato hash brown patties chunks in an aqueous medium at a temperature from about 170° to 220° F. for about 2 to 20 minutes;
c. further cooking the frozen sweet potato hash brown patties chunks in an oil at a temperature from about 300° to 375° F. for about 0.25 to 2 minutes;
d. mixing the frozen sweet potato hash brown patties chunks cooked in oil with an aqueous solution of starch, gum or mixtures thereof;
e. forming the frozen sweet potato hash brown patties chunks in a potato patty; and then
f. freezing the frozen sweet potato hash brown patties at a temperature of about −30° to −60° F.

20. The method of claim 19 wherein the aqueous solution of starch, gum or mixtures thereof contains from about 3 to 25% by weight of starch or gum or mixtures thereof.

21. The method of claim 20 wherein the aqueous solution of starch, gum or mixtures thereof is mixed with the oil cooked frozen sweet potato hash brown patties chunks at a rate to provide from about 5 to 20 grams of starch, gum or mixtures thereof per 100 grams of frozen sweet potato hash brown patties chunks.

22. The method of claim 19 wherein the frozen sweet potato hash brown patties chunks cooked in the aqueous medium are surface dried at a temperature of about 120° to 180° F.

23. The frozen sweet potato hash brown patties prepared by the method of claim 19.
